(19) United States
(12) Patent Application Publication
(10) Pub. No.: US 2002/0163445 A1
(43) Pub. Date: Nov. 7, 2002

(54) Aircraft takeoff acceleration monitor, " ATAM"

(76) Inventor: Marcus Fleming Cooper, Shreveport, LA (US)

Correspondence Address: MARCUS FLEMING COOPER, The Glen, Apt. 211, 403 E. Flournoy-Luca Rd., Shreveport, LA, 71115, US

(21) Appl. No.: 09/733,671

(22) Filed: Dec. 11, 2000

Related U.S. Application Data
(60) Provisional application No. 60/170,007, filed on Dec. 9, 1999.

(51) Int. Cl. G08B 21/00

(52) U.S. Cl. 340/945; 340/960

(57) ABSTRACT

It is a known fact that the lower the takeoff linear acceleration is, the longer will be the takeoff distance. Phenomenal aviation development has occurred in the 96 years since Kitty Hawk; however, Pilots still have only two linear acceleration sensors to tell him if the aircraft acceleration is being abnormally degraded during takeoff. They are:

The seat of his pants feel &

His gut feeling. Neither can be trusted.

This proposed Patent will permit the pilot to check the takeoff acceleration as soon as takeoff power is applied and permit him to continue monitoring the acceleration until lift off.

This AIRCRAFT TAKEOFF ACCELERATION MONITOR (ATAM) SYSTEM includes a linear acceleration indicating instrument that is to be mounted directly in the line of sight of the Pilot as he looks down the runway during Takeoff. During a normal takeoff the needle of the instrument will immediately move to the “GO” position, when the takeoff power is applied, and.

During a normal takeoff, the needle of this instrument will remain at the “GO” position until aircraft liftoff, unless some non programmed event occurs that degrades the acceleration. Should the magnitude of any degradation cause the needle to decline to the predetermined “ABORT” position, a warning light will light and a warning sound will occur.

### BACKGROUND CREATES NEED FOR PROPOSED INVENTION

A safe takeoff requires that the aircraft achieves adequate net thrust. Many of the factors that could reduce the net thrust may not show up on the instrument panel and are so subtle the pilot may not notice them, however, they could be serious enough to prevent the aircraft from reaching takeoff speed before reaching the abort condition or the end of the runway. For example:

Reduced engine power

Too low tire pressure

Dragging brakes

Malfunctioning thrust reverser

Slush or standing water on runway

Ingestion into engines of runway trash and birds

Improper position of flaps and drag slats.

Runway slope

In the past there have been several aircraft takeoff accidents in which non programmed events occurred during the take off causing a reduction in the normal acceleration. The Author has second hand knowledge of historical accidents described below which may have been avoided and saved lives if the device described in this Patent had been available.

1. Shortly after the Boeing 707 aircraft were placed into regular service one 707 came to rest beyond the takeoff end of the runway at New York's Idle Wild airport. During takeoff, heavy rain was falling and a bow wave of water built up ahead of the wheels which prevented the aircraft from accelerating to takeoff speed.

2. A jet airliner taking of from Washington National airport had just enough energy to clear the Mariett Motel before plunging into the Potomac River. Obviously, there was insufficient acceleration to make a successful takeoff. This accident might have been avoided if this proposed ATAM had been available.

3. A cargo jet crashed at the takeoff end of the runway in Newfoundland, because of the malfunction of a thrust reverser.

4. During W.W.II, bomber aircraft were operating at takeoff weights in-excess of the design gross weight. Some of the losses would have been prevented if the crew had timely knowledge when there was an abnormal decline in net takeoff acceleration.

5. A large USAF cargo aircraft in Alaska and a passenger jet at Boston crashed because of bird ingestion into the engines.

### ATAM DESIGN

There is a definite need for an instrument that will inform the pilot whenever sub normal takeoff deceleration occurs. Since, takeoff acceleration declines during takeoff, a simple acceleration sensor would likewise decline approximately 20%. This alone would force the pilot to make a judgment call as to whether the decline is normal or due to a serious problem. This ambiguity is eliminated by summing the declining acceleration and the increasing ram air pressure as aircraft takeoff speed increases as illustrated in drawings: FIG. 2A, FIG. 2B,+FIG. 2C. FIG. 2C shows that the voltage at the rotation velocity has been amplified to the same level as the initial takeoff voltage. Consequently the needle of the cockpit “GO/Abort Instrument remains at the “GO” position until aircraft liftoff, unless there is a problem.

The component which causes the above to happen is a box approximately 3″×3.5″1″ which can be placed in an easily accessible place in the cockpit. Within this box are the Acceleration sensor, The RAM AIR transducer, and the Voltage amplifier. This box sums up and transmits the corrected voltage to the cockpit “GO/ABORT”. During a normal takeoff a constant voltage is supplied that results in the needle of the “GO/AB: remaining at the “GO” position during the entire takeoff. An abnormal decline in acceleration would cause the needle to decline from the “GO” position to the “ABORT” position when appropriate.

### DRAWINGS

FIG. 1 Illustrates that the ground attitude of tail wheel type aircraft imposes such a small error, a gyro stabilized platform is not required.

FIG. 2A Acceleration during aircraft takeoffs declines approximately 20%. While rapidly using up runway, this significant decline would require the pilot to make a time consuming judgment call as to whether the decline is normal or caused by a malfunction.

FIG. 2B shows that by adding the ram air pressure on top of drawing 2A helps, but will not eliminate the problem described by FIG. 2A.

FIG. 2C shows that by adjusting the voltage of the ram air upward with the voltage amplifier the needle of the cockpit instrument can me made to remain at the GO position thru out the takeoff.

FIGS. 3A, 3B, & 3C are a block diagram of the complete ATAM system.

FIG. 3A, The Control Box converts the ram air and the aircraft acceleration into volts which are then adjusted by the voltage amplifier rheostat and fed to the voltmeter of the pilot's instrument.

FIG. 3B, This instrument is a voltmeter that may be rotated clockwise and counterclockwise inside its fixed case by a knurled knob. Its face has a black arrow that is manually adjusted to a ± position on the adjacent fixed scale that is introduced into the ATAM.

FIG. 4A is the condition where there are no departures from standard conditions of sea level density altitude, maximum design gross weight, maximum take off power and level runway. Since there are no deviations the small black arrow in the window is positioned at zero and during a normal takeoff the voltmeter arrow is pointing toward the “GO” position.

FIG. 4B is the condition where the maximum gross weight is reduced by 20%. In this case the aircraft is lighter and its takeoff acceleration will be 20% greater causing the voltmeter needle is climb 20% higher from its zero position. Therefore, the voltmeter must be rotated 20% counter clockwise within its case. Then, the little black arrow will point to minus 20% and the voltmeter needle will point to GO during a normal takeoff. the system is biased for the variations in variable data is incorporated into the System so that the acceleration needle of the “GO/ABORT’ pilot's Instrument will remain in the “GO” position throughout the takeoff unless an abnormal deceleration occurs because of a malfunction. It also warns the pilot to ABORT the takeoff when appropriate.

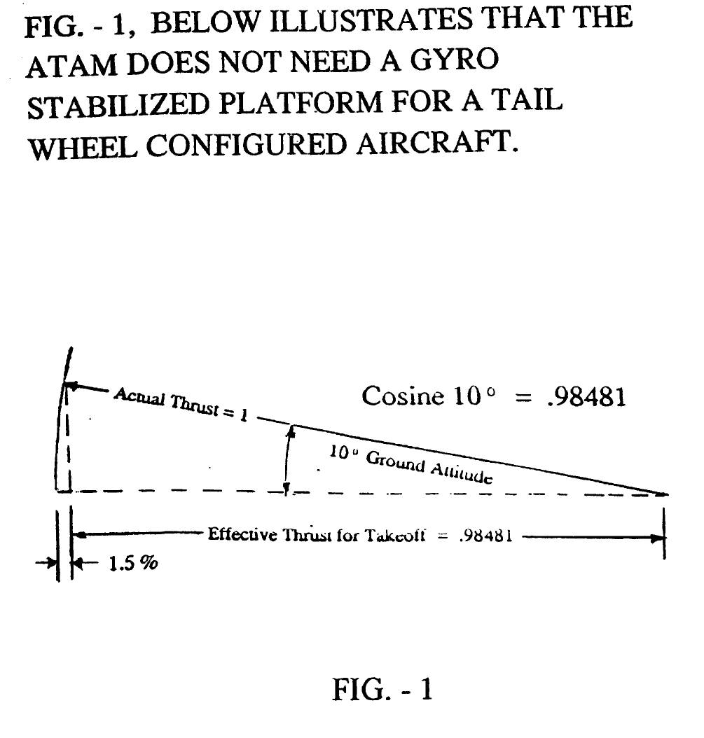

### MATING OF ATAM TO EACH TYPE AIRCRAFT

Each individual human has his or her own distinctive DNA and set of fingerprints and no two are alike. Likewise each different type aircraft will likely have a different combination power loading, wing loading, aerodynamic drag, rolling drag, etc. For lack of a better term: “WHEEL PRINT”.

This will affect the amount of linear acceleration when takeoff power is added at the beginning of takeoff and the acceleration just before aircraft rotation for takeoff.

During takeoff the aircraft linear acceleration declines as speed during takeoff increases. Tests on the Gulfstream IV declined 18%,

If Aircraft linear acceleration only were to be displayed to the pilot he would see a declining needle position as he progressed down the runway. This would require the pilot to make a subjective evaluation as to whether the rate of decline is normal or is the result of declining thrust or abnormal drag.

Fortunately, ram air pressure increases with increase in speed. This provides a way to keep the needle of the pilot's GO/ABORT instrument at the “GO” position during a normal takeoff and still decline when abnormal deceleration occurs.

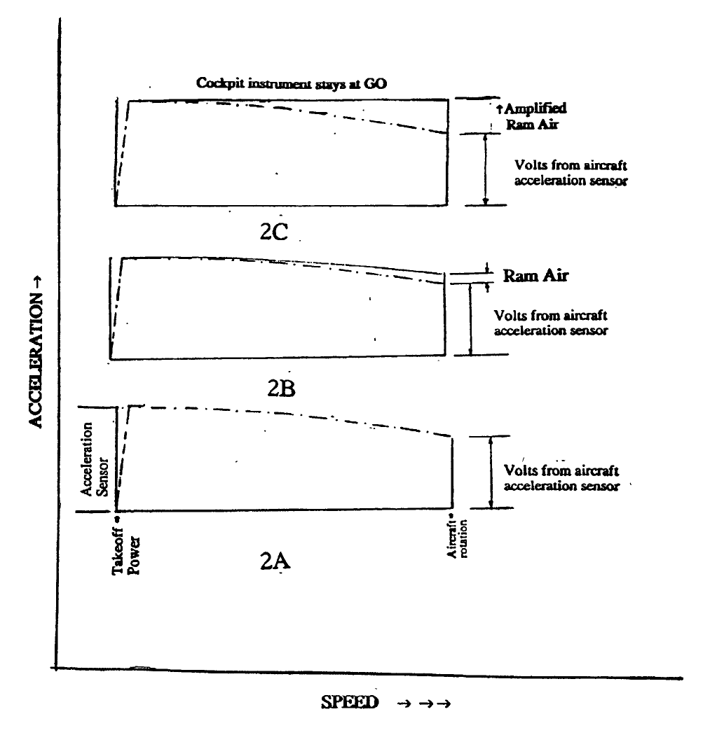

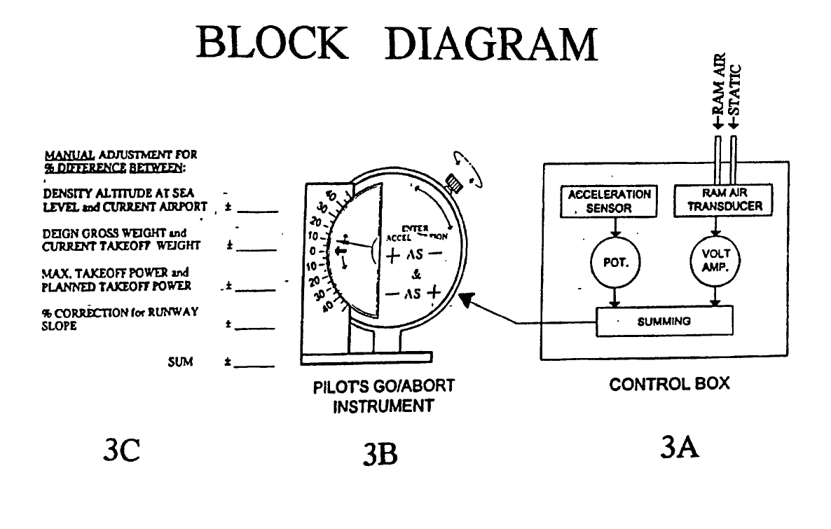

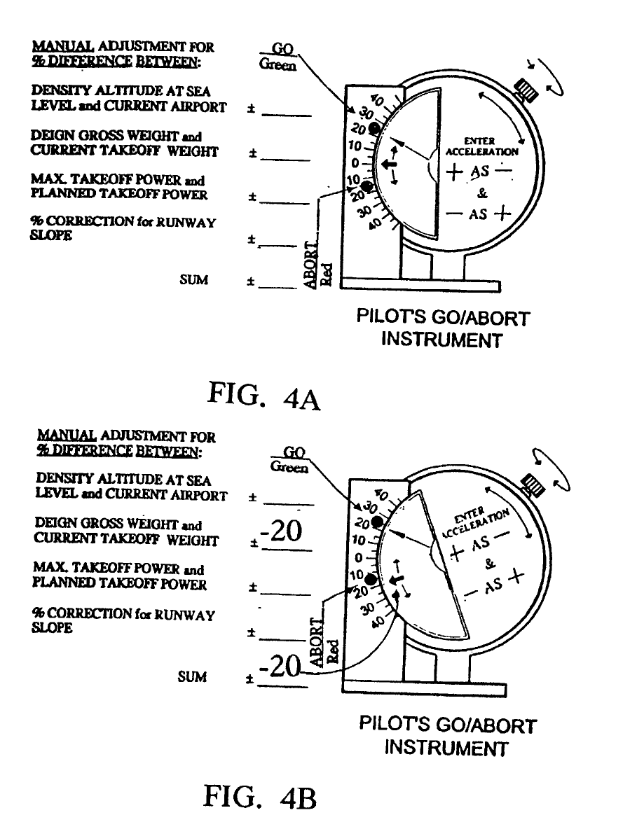

FIG. 2A illustrates a plot of only aircraft acceleration.

FIG. 2B illustrates the addition of ram air;

FIG. 2C illustrates the amplification of ram air voltage;

THE TEST PROCEDURE For mating the ATAM System to each different type aircraft is:

1. Determine the plus or minus SUM of % differences between the

A. Design Gross weight and the present Takeoff weight

B. Existing Density Altitude Vs Sea level Standard

C. Max. Takeoff Power Vs intentional reduced Power

D. Correction for Runway Slope

2. Enter this Sum into the “GO/ABORT” Instrument by Rotating it Clockwise or Counter clockwise to align its black Arrow with the corresponding % point on the Fixed Scale of the “GO/ABORT” Instrument

3. During Aircraft Takeoff:

A. As soon as takeoff power is applied, adjust the “GO/ABORT” needle to the “GO” position with the Aircraft Acceleration Rheostat which is located on the System Control Box.

B. During the takeoff roll maintain the needle at the GO position with the Ram Air Rheostat located on the System Control Box. Fix Ram Air Rheostat in last position

The ATAM is now Mated to that Specific Aircraft.

### ATAM, PRE TAKEOFF CHECKLIST

1. Before going to aircraft; determine percent difference between:

Density altitude at sea level and takeoff airport ±______

Design gross weight and current takeoff weight ±______

Maximum takeoff power and current power ±______

Runway slope correction ±______

Percent Sum ±______

### ″

ROTATE COCKPIT INSTRUMENT TO PLACE SMALL BLACK ARROW OPPOSITE ABOVE PERCENT SUM

Increased Acceleration positioned to Minus &

Increased Acceleration positioned to Plus

ATAM NOT MATED TO AIRCRAFT:

FOLLOW MATING INTERACTIONS

ATAM MATED TO AIRCRAFT:

WHEN TAKEOFF POWER IS APPLIED ADJUST COCKPIT INSTRUMENT NEEDLE TO GO POSITION

1. See Drawings 3A, 3B and 3C. The graphical stacking of the plots of voltages vs. speed generated during aircraft takeoff by the linear acceleration sensor and the ram air transducer as increased by the voltage amplifier results in the voltage of the top line of drawing 2C being constant during takeof. This will cause the needle of the ATAM cockpit instrument to remain at the GO position, during takeoff unless non programmed deceleration occurs. As soon as takeoff power is applied, the needle of the cockpit instrument will move to the GO position indicating that the engines are producing programmed power and during takeoff the needle will remain at the GO position unless subnormal acceleration occurs. Should the needle descend to the ABORT potion before the aircraft reaches V1 speed, immediate takeoff ABORT procedure should be initiated.

2. The ATAM cockpit instrument is a unique design. It is a simple voltmeter whose mechanism, including its face, is rotatable L & R inside its fixed case. Its purpose is to manually bias the ATAM system to correct for the ± sum of the % departure from standard of the variables that affect the takeoff distance, See drawings 4A & 4B.

3. Each different type of aircraft has a different amount of induced drag, skin drag, and rolling friction during takeoff; therefore, the ATAM must be mated to each type aircraft, This may be accomplished during the first take off. Read: Mating of ATAM to each type aircraft. The last step in this mating is to adjust, during takeoff, the ram air voltage rheostat so as to maintain the needle in the GO position. This rheostat is then secured in that position for all future takeoffs by that aircraft. If the takeoff procedure is followed then the needle of the cockpit trument will remain in the Go poition, unless there is an abnomal degradation in acceleration.

4. The complete ATAM system will weigh less than three pounds, will use less than one ampere of aircraft's electricity The ATAM″s control box needs to connect, thru T fittings to the pressure and static lines between aircraft's pitot head and airspeed instrument.

5. Because of the ATAM's simplicity it should be very reliable. The small control box should be assessable to both pilots and the cockpit instrument should be mounted on top of the pilot's glare shield and in the pilot's line of sight as he looks down the runway during takeoff.
